(19) United States
(12) Patent Application Publication
(10) Pub. No.: US 2005/0288975 A1
(43) Pub. Date: Dec. 29, 2005

(54) Apparatus and methods for helping a user of a mobile platform communication system

(76) Inventors: Ronald P. O'Byrne, San Clemente, CA (US); Carlos R. Gerren, Rancho Santa Margarita, CA (US)

Correspondence Address: HARNESS, DICKEY, & PIERCE, P.L.C, 7700 BONHOMME, STE 400, ST. LOUIS, MO, 63105, US

(21) Appl. No.: 11/109,272

(22) Filed: Apr. 19, 2005

Related U.S. Application Data
(60) Provisional application No. 60/563,839, filed on Apr. 20, 2004.

(51) Int. Cl. G06F 17/60; G06F 15/16

(52) U.S. Cl. 705/6; 705/5; 709/202

(57) ABSTRACT

A method of providing help to a passenger in connection with a communication system on board a mobile platform. The method includes informing a consultant as to a plurality of aspects of the communication system, and providing the passenger in transit with personal access to the consultant.

### CROSS-REFERENCE TO RELATED APPLICATIONS

This application claims the benefit of U.S. Provisional Application No. 60/563,839, filed on Apr. 20, 2004. The disclosure of the above application is incorporated herein by reference.

### FIELD OF THE INVENTION

The present invention relates to communication systems on board mobile platforms such as aircraft and, more particularly, to providing assistance to users of a network provided on board a mobile platform.

### BACKGROUND OF THE INVENTION

Passengers aboard mobile platforms such as aircraft and ships may be provided with access to bi-directional communications services via satellite link between a ground-based control segment and a mobile RF transceiver system carried on the mobile platform. One such system makes it possible for users on a mobile platform to interface with an on-board server by using a laptop, seat-back-mounted computer/display, or other computing device. Each user can independently request and obtain, for example, Internet access, company intranet access, and/or live television programming.

Such a system can provide a wide variety of options for a passenger, who might need assistance at least initially in learning how to connect with and use the system. Questions might arise not only in connection with technical aspects of the system, but also in connection, for example, with billing and/or account services in connection with system use by a passenger. It would be desirable to provide passengers with assistance quickly and directly, to optimize their use and enjoyment of the system.

### SUMMARY OF THE INVENTION

The present invention, in one preferred implementation, is directed to a method of providing help to a passenger in connection with a communication system on board a mobile platform. The method includes informing a consultant as to a plurality of aspects of the communication system, and providing the passenger in transit with personal access to the consultant.

In another configuration, the present invention is directed to an apparatus for providing help to a passenger in connection with a communication system on board a mobile platform. The apparatus includes at least one transit location in which a passenger in transit may be found, and a consultant service whereby a consultant informed as to a plurality of aspects of the system is personally available to the passenger in the location.

In yet another implementation, the invention is directed to a method of providing help to a passenger in connection with a communication system on board a mobile platform. A consultant is provided with access to one or more help venues of the communication system while the consultant is in at least one of a pre-board area and a cabin of the platform. The passenger is provided with personal access to the consultant.

The features, functions, and advantages can be achieved independently in various embodiments of the present inventions or may be combined in yet other embodiments.

### BRIEF DESCRIPTION OF THE DRAWINGS

The present invention will become more fully understood from the detailed description and the accompanying drawings, wherein:

FIG. 1 is a block diagram view of a communication system and help apparatus in accordance with one configuration of the present invention; and

FIG. 2 is a block diagram of a mobile system carried by a mobile platform.

### DETAILED DESCRIPTION OF THE PREFERRED EMBODIMENTS

The following description of the preferred systems and methods is merely exemplary in nature and is in no way intended to limit the invention, its application, or uses.

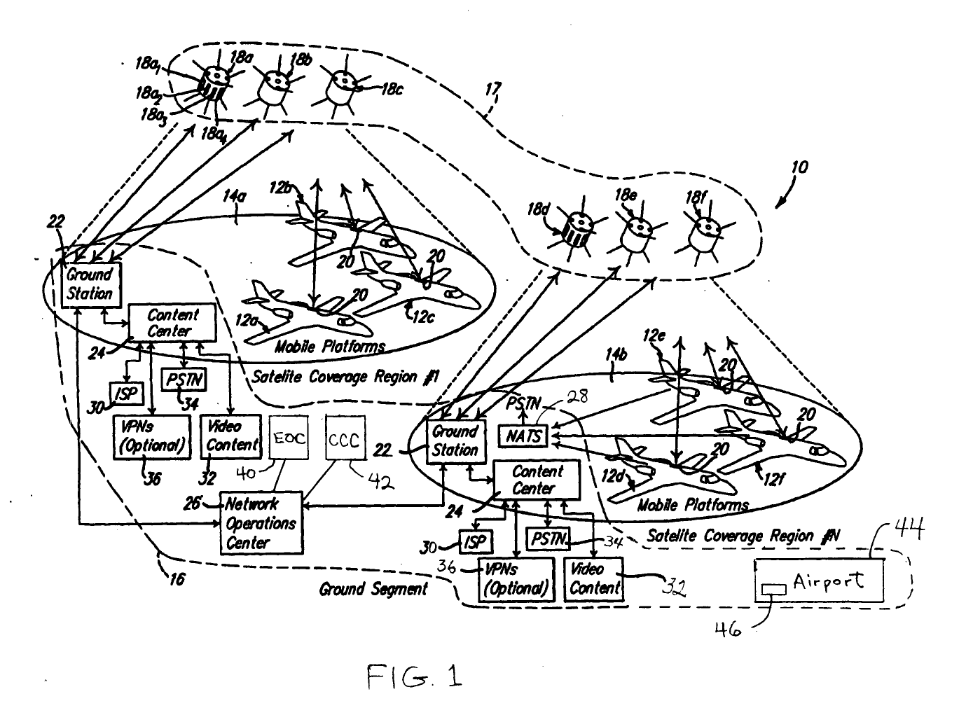

A system generally indicated in FIG. 1 by reference numeral 10 provides bi-directional data services and live television programming to mobile platforms 12a-12f in one or more coverage regions 14a and 14b. The system 10 includes a ground-based segment 16, a plurality of orbiting satellites 18a-18f, and a mobile system 20 disposed on each moving platform 12. Each mobile system 20 is in bi-directional communication with at least one of the satellites 18.

As described below, the present invention in one embodiment is directed to an apparatus for providing help to a passenger in connection with the system 10. The moving platforms 12 could include aircraft, cruise ships or any other moving vehicle. Thus the illustration of the moving platforms 12 as aircraft herein, and the reference to the mobile platforms as aircraft throughout the following description, should not be construed as limiting the applicability of the system 10 and/or the present invention to only aircraft.

The ground segment 16 includes at least one ground station 22 in bi-directional communication with at least one of the satellites 18. The ground station 22 also is in bi-directional communication with an associated content center 24. Each ground station 22 also is in bi-directional communication with a network operations center (NOC) 26 via a terrestrial ground link or other suitable communication link. An optional air telephone system 28, e.g. the National Air Telephone System (NATS), may provide a return link from a mobile platform 12 alternative to that provided by the satellites 18.

The content center 24 in each coverage region 14 is in communication with a variety of external data content providers and controls the transmission of video and data information received by it to the associated ground station 22. The content center 24 is in contact, for example, with an Internet service provider (ISP) 30, a video content source 32 and a public switched telephone network (PSTN) 34. Optionally, the content center 24 can also communicate with one or more virtual private networks (VPNs) 36. The ISP 30 provides Internet access to occupants of aircraft 12a via access stations as further described below. The video content source 32 may provide live television programming.

The NOC 26 may perform traditional network and data management, user authentication, accounting, customer service and billing tasks. Alternatively or additionally, such tasks may be handled wholly or in part at an enterprise operations center (EOC) 40 and/or a customer care center (CCC) 42. As shall be further described below, a plurality of help resources are available to a passenger who wishes to use the system 10. For example, passengers in transit, e.g., at an airport terminal 44, may make use of a consultant service 46 available, e.g., in an airport pre-board area or lounge.

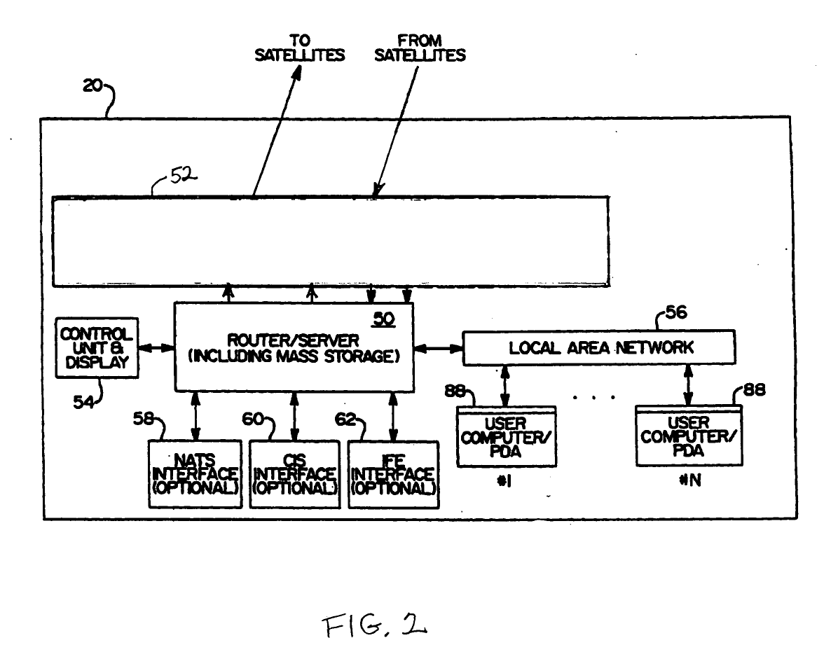

Referring again to components of the system 10, the mobile system 20 disposed on each aircraft 12 is described in FIG. 2. Each mobile system 20 includes a data content management system in the form of a router/server 50 (hereinafter “server”). The server 50 is in communication with a communications subsystem 52 that transmits signals to, and receives signals from, the satellites 18. Signals received via one of the satellites 18 could include direct broadcast satellite (DBS) transmissions from broadcast satellite service providers.

The server 50 also is in communication with a control unit and display system 54 and a distribution system in the form of a local area network (LAN) 56. Optionally, the server 50 can also be configured for operation in connection with a National Air Telephone System (NATS) 58, a crew information services system 60 and/or an in-flight entertainment system (IFE) 62. The local area network (LAN) 56 may be used to interface the server 50 to a plurality of access stations 88 associated with each seat location on board the aircraft 12. Each access station 88 can be used, for example, to provide direct two-way communication between the server 50 and a user's laptop computer.

It should be understood that the various elements of the system 10 as described with reference to FIGS. 1 and 2 are exemplary only. The present invention can be implemented in connection with various communication system configurations. In one implementation of the present invention, a plurality of help venues are available to provide assistance to a passenger in connection with the system 10. Such venues can include, for example, the network operations center 26, the enterprise operations center 40, the customer care center 42 and/or other locations. A passenger may access such venue(s), for example, by email, telephone, text chat, and/or fax. Of course, regular mail may also be used to contact such help sources.

Information gathered through such venues may be used in various ways to design modifications of various aspects of the system 10. For example, information pertaining to a sequence of actions taken in response to an inquiry by a passenger to a call center at the customer care center 42 may be tracked and saved throughout such sequence. Information gathered in such manner may be used to improve the system 10.

Help may be available to a passenger, for example, twenty-four hours a day and seven days per week with respect to technical support and/or billing and account support. Other help resources available to a passenger may include, for example, an internet portal available to passengers on the ground, an internet portal available to passengers in flight, an online FAQs (frequently asked questions) feature available to users having laptops compatible with the system 10 regardless of login or account status, seatback cards and other written materials available online and/or in hard copy.

Such help sources and venues also may be accessible, as further described below, by one or more help consultants who may be personally available to a passenger in transit. Specifically, in one implementation of the present invention, a method of providing help to a passenger in connection with the system 10 includes informing a consultant as to a plurality of aspects of the system 10 and providing the passenger in transit with personal access to the consultant. Such consultant(s) may be personally available to passengers, for example, through the consultant service 46 in a pre-board area of the airport 44 and/or on board a platform 12.

In one implementation, a consultant may provide information to passengers in the following exemplary areas: hardware/software needed to access the system 10, physical connectivity requirements, availability of power supply; system 10 service terms and conditions; system 10 service availability; pricing arrangements and/or billing procedures. A consultant also may provide help and support to a passenger, for example, in connection with registration for using the system 10, logging in to the system 10, setting laptop configuration settings, accessing the Internet, using an Internet portal; a VPN and/or email, and/or addressing billing issues.

A consultant also may gather information from passengers, including but not limited to user experience and expectations, likes and dislikes, satisfaction level regarding connection speed, preference as to wireless or wired LAN service, and user recommendations. Additionally or alternatively, the system 10 and the consultant service 46 may be marketed, for example, by a consultant or other person distributing marketing material in one or more locations in which the consultant service 46 is available. In one implementation, the consultant service 46 is provided by a platform provider, e.g., an airline operating a fleet of platforms 12.

A consultant may be trained, for example, in email and internet usage, VPN technology and clients, instant messenger and text chat, LAN and WLAN technologies, and various operating systems, browsers, and system infrastructures such as routers, switches, servers and hotspots. Such training is administered before a consultant provides user support as described above. A consultant also may be provided with equipment such as a laptop, a laptop configuration tester, a cell phone and a digital camera. Using the laptop tester and/or printed help materials as described above, a consultant may check user-provided laptops for compatibility with the system 10. Preferably such testing is performed before a passenger boards a platform 12, to expedite the passenger's use of the system 10 once on board.

A consultant on board a platform 12 can provide guidance to a cabin crew of the platform, for example, in understanding the system 10, identifying any outage or disruption of the system 10, in performing any resetting of the system 10, and reporting any trouble with the system 10. A consultant may create and/or maintain logs and/or reports for use in troubleshooting. Such logs and/or reports may be useful, for example, to personnel responding to calls from users and/or consultants at the customer care center 42.

The foregoing apparatus and methods make it possible to provide a passenger rapidly with personal, individualized help. Where a consultant is available in a pre-flight location such as an airport lounge, opportunities can be maximized for preparing a passenger to use the communication system successfully once in flight.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

1. A method of providing help to a passenger in connection with a communication system on board a mobile platform, the method comprising:
informing a consultant as to a plurality of aspects of the communication system; and
providing the passenger in transit with personal access to the consultant.

2. The method of claim 1, wherein in transit comprises at least one of the following: in a pre-board area, and on board the platform.

3. The method of claim 1, wherein informing a consultant comprises making at least one of technical help and billing/account help available to the consultant via a plurality of help venues of the communication system.

4. The method of claim 1, further comprising assisting the passenger in establishing operation of a personal computing device in connection with the system, the assisting performed by the consultant.

5. The method of claim 1, further comprising providing personal access to the consultant to a crew of the platform.

6. The method of claim 1, further comprising:
receiving a report from the consultant; and
updating the communication system in response to the report.

7. The method of claim 1, further comprising obtaining feedback from the passenger via the consultant.

8. The method of claim 1, wherein the providing with personal access is performed by a provider of the mobile platform.

9. The method of claim 1, further comprising advertising availability of the consultant while the passenger is in transit.

10. An apparatus for providing help to a passenger in connection with a communication system on board a mobile platform, the apparatus comprising:
at least one transit location in which a passenger in transit may be found; and
a consultant service whereby a consultant informed as to a plurality of aspects of the system is personally available to the passenger in the location.

11. The apparatus of claim 10 wherein the consultant service provides help to the passenger preparing to use a personal computing device in connection with the communication system.

12. The apparatus of claim 10, further comprising a plurality of help venues of the communication system to which the consultant has access.

13. The apparatus of claim 10, wherein the at least one transit location comprises at least one of the following: a pre-board area, and a cabin of the platform.

14. The apparatus of claim 10, further comprising an advertising service whereby the consultant service is made known to the passenger.

15. A method of providing help to a passenger in connection with a communication system on board a mobile platform, the method comprising:
providing a consultant with access to one or more help venues of the communication system while the consultant is in one of a pre-board area and a cabin of the platform; and
providing the passenger with personal access to the consultant.

16. The method of claim 15, wherein the passenger comprises a platform crew member.

17. The method of claim 15, wherein the one or more help venues comprise at least one of the following: a network operations center, an enterprise operations center, and a customer care center.

18. The method of claim 15, further comprising reporting a condition of the system to one of the one or more help venues, said reporting performed by the consultant.

19. The method of claim 15, further comprising assisting the passenger in operating a personal computing device of the passenger in connection with the system, said assisting performed by the consultant.
